(19) United States
(12) Patent Application Publication
(10) Pub. No.: US 2011/0163618 A1
(43) Pub. Date: Jul. 7, 2011

(54) Rotating Electrical Machine

(75) Inventors: Hiroshi Kanazawa, Hitachiota-shi (JP); Shoichi Kawamata, Hitachi-shi (JP); Shinji Sugimoto, Hitachi-shi (JP)

(73) Assignee: Hitachi, Ltd., Tokyo (JP)

(21) Appl. No.: 12/980,576

(22) Filed: Dec. 29, 2010

(30) Foreign Application Priority Data
Jan. 4, 2010 (JP) 2010-000029

(51) Int. Cl. H02K 19/06

(52) U.S. Cl. 310/46

(57) ABSTRACT

This rotating electrical machine includes a stator, a rotor having a plurality of convex portions on its surface that opposes the stator and extending along its direction of rotation, a magnet, and a frame made from magnetic material. The number of poles of the stator is the same as the number of magnetic convex poles of the rotor. The rotor is made from a plurality of plates of magnetic material, superimposed and skewed along the axial direction. A magnetic circuit is set up in the frame so that the magnetic flux of the magnet flows therein from the central portion of the rotor. And the magnet is a permanent magnet shaped as a cylinder, is single-pole magnetized along the radial direction, and is provided between the outer circumferential surface of the stator in the circumferential direction and the inner circumferential surface of the frame in the circumferential direction.

### INCORPORATION BY REFERENCE

The disclosure of the following priority application is herein incorporated by reference: Japanese Patent Application No. 2010-000029 filed Jan. 4, 2010.

### BACKGROUND OF THE INVENTION

1. Field of the Invention

The present invention relates to a rotating electrical machine that exploits reluctance.

2. Description of Related Art

As a method of enhancing the output of a rotating electrical machine that employs reluctance, as disclosed in the following three reference documents, it is per se known to equip the rotating electrical machine with a magnet. In Japanese Laid-Open

Patent Publication 2004-88904 a structure is disclosed in which a permanent magnet is disposed between the poles of the stator; in Japanese Laid-Open Patent Publication 2004-357489 a structure is disclosed in which a plurality of permanent magnets that are magnetized in single direction and disposed on the stator; and in International Patent Publication WO2005/091475A1 a structure is disclosed in which a plurality of permanent magnets or electromagnets are arranged on a frame that is provided to an end surface of the rotor in the axial direction.

### SUMMARY OF THE INVENTION

With the structures disclosed in the above mentioned Japanese Laid-Open Patent

Publications and the International Patent Publication, since the magnet is disposed at a location where it is difficult to cool the stator poles and so on, in some cases this necessitates the provision of a magnet whose performance does not easily deteriorate even at high temperature.

Thus, it is an object of the present invention to enhance the output power of a rotating electrical machine while still ensuring good cooling performance for a magnet thereof.

According to the 1st aspect of the present invention, a rotating electrical machine comprising a stator, a rotor, a magnet, and a frame, wherein: the rotor has a mechanical and/or a magnetic reluctance structure; the magnet is provided between an outer circumferential surface of the stator in circumferential direction and an inner circumferential surface of the frame in circumferential direction; and the frame is made of magnetic material.

According to the 2nd aspect of the present invention, in a rotating electrical machine according to the 1st aspect, it is preferred that the rotor has, on its surface that opposes the stator, a plurality of convex portions along its direction of rotation; and the stator has a same number of poles as a number of convex portions of the rotor.

According to the 3rd aspect of the present invention, in a rotating electrical machine according to the 1st aspect, it is preferred that the rotor has a substantially U-shaped cavity portion on its outer edge portion; and the stator has a same number of poles as a number of convex magnetic poles of the rotor.

According to the 4th aspect of the present invention, in a rotating electrical machine according to the 2nd aspect, it is preferred that the rotor is made from a plurality of plates of magnetic material, superimposed along axial direction and skewed along axial direction.

According to the 5th aspect of the present invention, in a rotating electrical machine according to the 1st aspect, it is preferred that the magnet is a cylindrical permanent magnet, and is single-pole magnetized in its radial direction.

According to the 6th aspect of the present invention, in a rotating electrical machine according to the 1st aspect, it is preferred that the magnet is an electromagnet.

According to the 7th aspect of the present invention, in a rotating electrical machine according to the 6th aspect, it is preferred that the magnet is constituted with a plurality of permanent magnet portions made by dividing a cylindrical permanent magnet in its axial direction, and is provided between an outer circumferential surface of the stator in circumferential direction and an inner circumferential surface of the frame in circumferential direction; wherein the cylindrical permanent magnet is single-pole magnetized in its radial direction.

According to the 8th aspect of the present invention, a rotating electrical machine comprising a stator, a rotor, a frame, and a plurality of magnets, wherein: the rotor has a mechanical and/or a magnetic reluctance structure, and has a substantially U-shaped cavity portion on its outer edge portion; and the stator has a same number of poles as a number of convex magnetic poles of the rotor; the magnets are embedded in the rotor, corresponding in number to the number of the convex magnetic poles of the rotor; and the frame is made of magnetic material.

According to the 9th aspect of the present invention, a rotating electrical machine comprising a stator, a rotor supported by a shaft, a permanent magnet, and a frame, wherein the rotor has a mechanical or magnetic reluctance structure; and the permanent magnet is disposed between an outer circumferential surface of the rotor and the shaft.

According to the 10th aspect of the present invention, in a rotating electrical machine according to the 1st aspect, it is preferred that a magnetic circuit is set up in the frame so that a magnetic flux of the magnet flows from both central portions of both axial ends of the rotor towards both central portions of both axial ends the frame, where both of axial ends of the frame face respectively to both central portions of the rotor.

According to the 11th aspect of the present invention, an axial flow pump that uses a rotor according to the 2nd aspect as an impeller.

According to the present invention, it is possible to enhance the output power of a rotating electrical machine while still ensuring cooling performance for a magnet thereof.

### BRIEF DESCRIPTION OF THE DRAWINGS

FIG. 1 is a sectional view showing a first embodiment of a rotating electrical machine;

FIGS. 2A and 2B are perspective views showing the exemplary structures of a rotor of this machine;

FIGS. 3A and 3B show exemplary constructions of a magnet of this machine;

FIG. 4 is a sectional view of this first embodiment, for explaining its magnetic flux path;

FIG. 5 is a structural diagram of this first embodiment, for further explanation of its magnetic flux path;

FIGS. 6A, 6B are structural diagrams showing respectively the cases in which this first embodiment is applied to a three phase motor and to a single phase motor, and FIG. 6C shows an example of construction of the end portion of a stator pole causing different stop phases for a stator pole and a rotor pole facing to each other;

FIG. 7 is a structural diagram of this first embodiment, for explaining the magnetic path in its winding;

FIG. 8A is a figure for explaining the variation of magnetic flux passing through the winding of each phase of a three phase motor, and FIG. 8B is a figure for explaining the induced voltage due to this magnetic flux variation;

FIG. 9 is a sectional view showing a second embodiment;

FIG. 10 is a sectional view showing a third embodiment;

FIG. 11 is a sectional view showing an example in which this structure for a rotating electrical machine is applied to a pump;

FIG. 12A is a perspective view showing a rotating electrical machine provided with a magnetic reluctance structure as a fourth embodiment, and FIG. 12B is a perspective view showing a rotating electrical machine further provided with a cylindrical magnet at the central portion of the rotor;

FIGS. 13A and 13B are perspective views of two exemplary embodiments as a fifth embodiment; and

FIG. 14 is a structural diagram showing a sixth embodiment.

### DESCRIPTION OF THE PREFERRED EMBODIMENTS

In the following, various embodiments of the present invention will be explained with reference to the figures.

### Embodiment 1

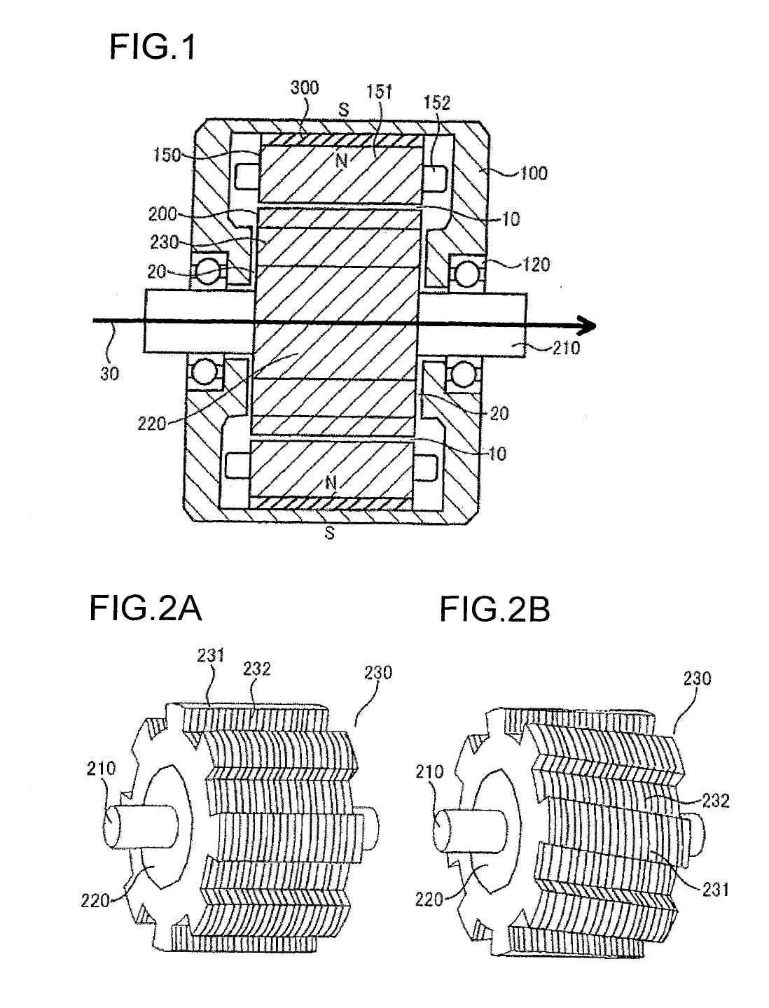

FIG. 1 is an axial sectional view showing a first embodiment of a rotating electrical machine of the present invention.

This rotating electrical machine includes a frame 100, a stator 150, a rotor 200, and a magnet 300.

The frame 100 is made from a magnetic material, and rotatably supports the rotor 200 via bearings 120. The stator 150 includes stator poles 151 and windings 152. The magnet 300 is provided between the inner circumferential surface of the frame 100 and the outer circumferential surface of the stator 150.

The inner circumferential surface of the stator 150 opposes the outer circumferential surface of the rotor 200 with a first gap 10 being defined between them. Moreover, the inner surface of the frame 100 opposes the end faces of the rotor 200 in the axial direction with second gaps 20 being defined between them. It should be understood that the axial direction is shown in the figure by the arrow 30.

Next, the structure of the rotor 200 will be explained with reference to FIG. 2(a). A shaft 210 is provided in the center of the rotor 200, a yoke 220 made from soft iron or the like is provided around the shaft 210, and rotor poles 230 are further provided around the yoke 220. The rotor core 230 is formed in a toothed shape, and has convex portions 231 and concave portions 232 that alternate along the circumferential direction. In the figure an example is shown in which the rotor core 230 is made by laminating together in the axial direction a plurality of thin plates that are made from a magnetic material such as magnetic steel sheet or the like. Since the magnetic resistance of the convex portions made in this manner is relatively low while the magnetic resistance of the concave portions is relatively high in comparison, a reluctance torque is obtained by the convex portions being attracted by the rotating magnetic field of the stator. In the following, a construction in which the magnetic resistance changes due to convexities and concavities of this type is termed a “mechanical reluctance structure”.

It should be understood that the yoke 220 is not essential; whether or not to employ such a yoke is determined depending upon the material of the shaft 210. For example, when a ceramic material is employed for the shaft 210, since the magnetic poles made of magnetic steel sheets can not be pressed into the shaft, the mechanical reluctance structure is provided with such a yoke 220.

FIG. 2B shows an example in which the rotor 200 is constructed to have a skew. In this figure, the skew is implemented by the angles of the superimposed magnetic steel sheets being changed a little at a time. By providing this skew, it becomes possible to reduce the torque ripple and the cogging torque. The skew angle is determined appropriately according to the application of the rotating electrical machine. This is because, although the torque ripple can be reduced if the angle is great, the average output power also decreases.

Since the rotor of this embodiment is built simply by superimposing a number of magnetic steel sheets, accordingly it is possible to provide a robust rotor while setting the skew in a simple and easy manner. Moreover, since no permanent magnets are provided on the outer circumferential surface of the rotor, it is possible to rotate the rotor at high speed without worrying about such a magnet flying off or the like due to centrifugal force.

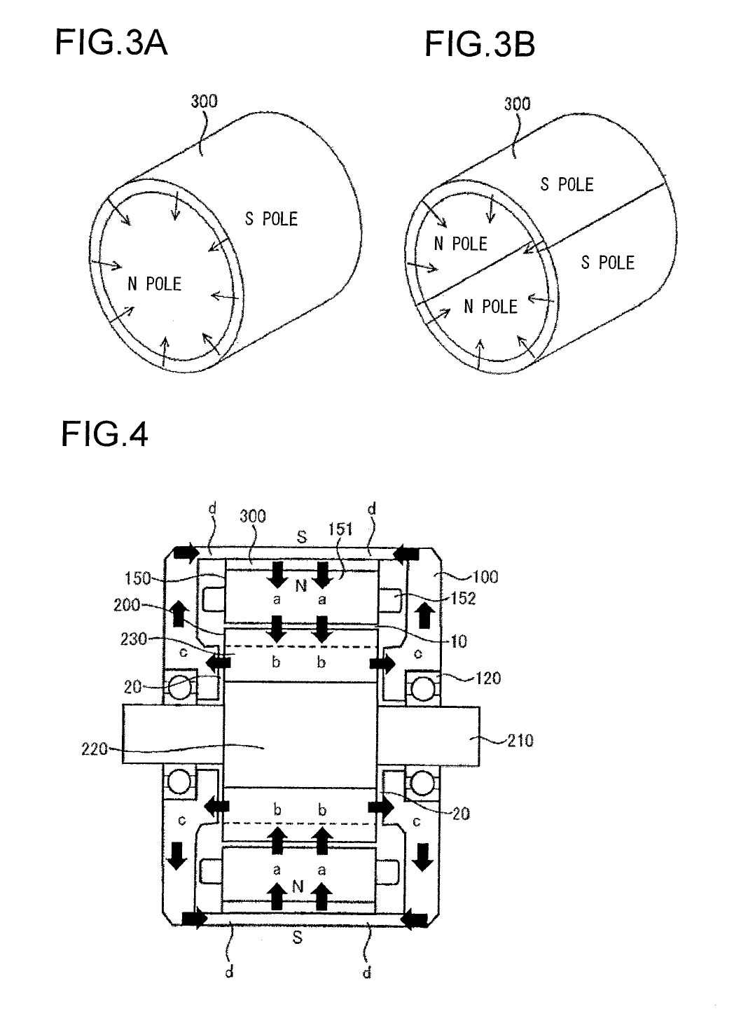

FIG. 3A shows an example of the magnet 300. This magnet 300 is a tubular hollow cylindrical magnet that is single-pole magnetized along the radial direction (i.e. so that the inner circumferential surface of the cylinder is magnetized with same polarity), and, in this embodiment, a permanent magnet that is single-pole magnetized around its circumferential direction with uniform magnetic pole strength is used. While in this embodiment the inner circumferential surface of this magnet 300 is its N pole while its outer circumferential surface is its S pole, the reversed structure would also be acceptable. While, with typical multi-pole magnetization, non-magnetized regions are created at the portions where the polarities change over, with the single-pole magnetization no such non-magnetized regions are created, so that the efficiency is good because the ratio of utilization of the magnet is 100%. Furthermore, if it proves to be difficult to form the permanent magnet in this kind of hollow cylindrical shape, it would also be acceptable to arrange to build up this cylindrical shape from a plurality of separate permanent magnets, according to requirements. FIG. 3B shows an example in which the cylinder is made as a combination of two half-cylindrical permanent magnets. Similarly, a plurality of magnet portions which are made by dividing a cylindrical permanent magnet in its axial direction may also be used.

While no example is shown in the figures, it would also be acceptable for the magnet 300 not to be a perfect cylinder but rather partially, provided that it is disposed in the circumferential direction between the inner circumferential surface of the frame 100 and the outer circumferential surface of the stator 150. One example of this could be the use of an electromagnet as the magnet 300.

Next, the flow of magnetic flux in the magnet 300 when no current is flowing in the windings 152 of the stator will be explained with reference to FIG. 4. This magnetic flux emerges from the inner circumferential surface of the magnet 300 (i.e. from its N pole) and links to the stator pole 151 (as shown by “a” in FIG. 4), and then mostly passes across the first gap 10 to the convex portions 231 of the rotor core 230 (as shown by “b”). Then the flux reaches the frame 100 via the second gaps 20 (as shown by “c” in FIG. 4), passes through the frame 100 in the outward radial direction (as shown by “d”), and returns to the S pole of the magnet 300. In this way, the magnetic flux of the magnet 300 excites the rotor core 230 in a steady manner. FIG. 5 is a perspective sectional view of the rotating electrical machine showing this flow of magnetic flux. Accordingly, in order to implement this type of magnetic flux flow, it is necessary for the frame 100 to be made from a material that is magnetic. It should be understood that, though in FIG. 5 the magnetic flux originating the magnet 300 is shown to flow from the central portion of one axial end portion of the rotor core 230 towards one axial end portion of the frame 100 facing to the axial end portion of the rotor core 230, a similar magnetic flux path is formed for the other axial end of the rotor core 230 and the other axial end of the frame 100 facing to this axial end portion of the rotor core 230. In other words, the magnetic flux from the magnet 300 is divided in 2 fluxes which flow further in the opposite directions, and each of these 2 magnetic fluxes flow through the frame 100 back to the magnet 300.

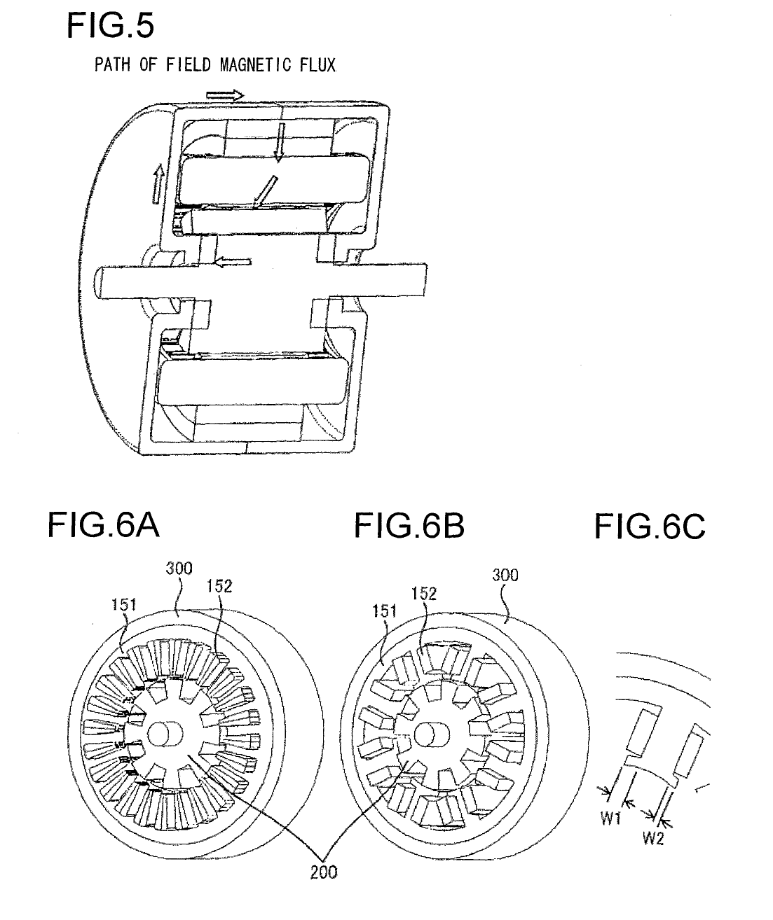

Whatever structure the stator 150 may have, the flow of magnetic flux described above is essentially the same. The stator 150 may carry a concentrated winding, a distributed winding, or a dispersal winding, and could be single phase, two phase, three phase, or the like. FIG. 6A is an example showing a case in which the stator carries a three phase windings of concentrated winding, while FIG. 6B shows the case in which it carries a single phase windings of concentrated winding. However, in these figures, the coil end portions are omitted. Moreover, the frame 100 is also omitted. In the case of the concentrated winding shown in FIG. 6B, the number of poles on the rotor and the number of poles on the stator are the same, and the angular pitches of their poles are also the same. However, in order for the rotor not to stop between stator poles, and moreover in order for starting to be easy, it is necessary for the gaps between the rotor poles and the stator poles to be made to be non-uniform, leading to cause different stop phases for the centers of the poles of the rotor and of the centers of the poles. Moreover the same beneficial effect may be obtained, for example by making these gaps non-uniform, due to the asymmetric shapes of the tip end portions W1 and W2 of the stator poles, as shown in FIG. 6C.

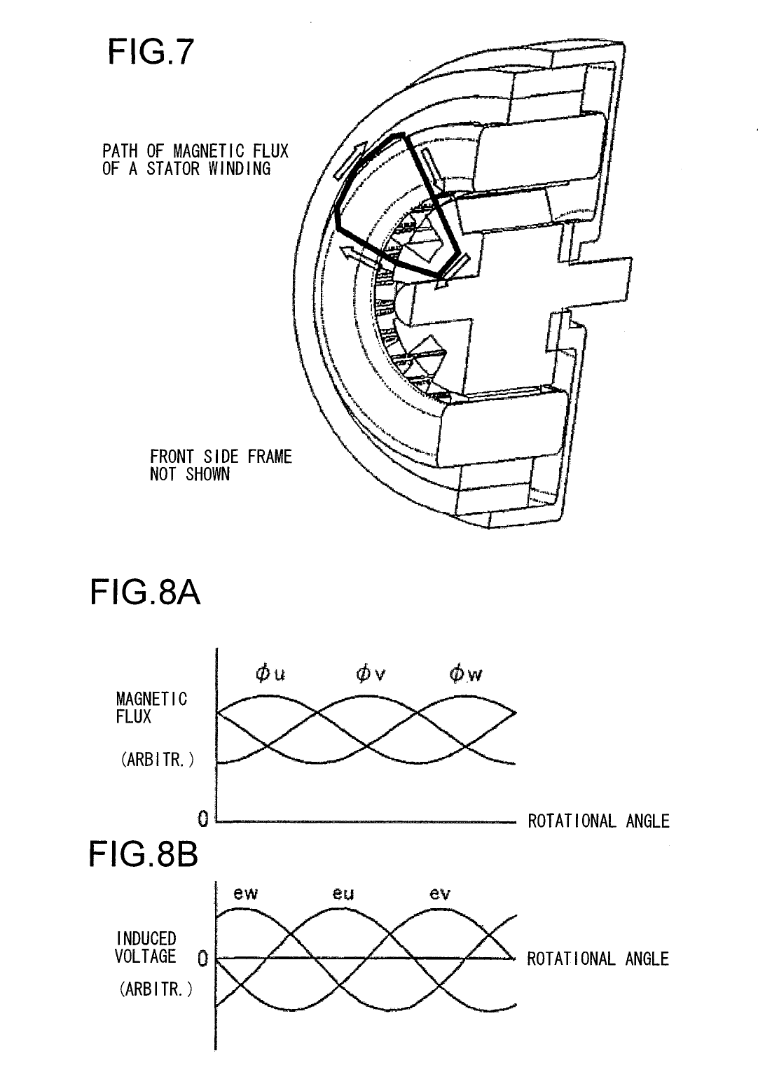

Next, an example will be explained in which the stator carries a three phase windings 152 of concentrated winding, through which magnetic flux is generated. The structure of the flow of magnetic flux in this winding is as shown in FIG. 7. And FIG. 8A is a graph showing the magnetic flux from the magnet 300 passing through a stator pole on which this three phase windings are wound, with magnetic flux in vertical axis and rotational angle of the rotor in the horizontal axis. The stator poles are excited steadily by the magnet 300. When the rotor 200 rotates, the magnetic resistance of the first gap 10 fluctuates similarly as shown in FIG. 8A. The magnetic flux from the magnet 300 which pass through the winding of each phase becomes a maximum when the winding of that phase and a convex portion 231 approach most closely together, and becomes a minimum when the winding of that phase and a concave portion 232 approach most closely together.

Since the magnetic flux from the magnet 300 passing through the winding of each phase fluctuates in this way due to the rotation of the rotor 200, an induced voltage is generated in each winding as shown in FIG. 8B. When this rotating electrical machine is to be employed as a motor, output torque can be obtained by supplying an electrical current whose phase is matched to that of this induced voltage, in a manner similar to that for a conventional motor. Since the magnitude of this induced voltage is proportional to the amount of change of the magnetic flux, it is possible to make the output torque greater by choosing a magnet 300 in which the residual magnetic flux is larger. Furthermore, the output torque can be increased by building the magnetic circuit so that the first gap 10 and the second gaps 20 are narrower.

Generally the output torque of a typical reluctance motor is small in relation to its physical structure because its rotor includes no permanent magnet, so that its output torque relies only upon the attractive force engendered when current flows in the windings of the stator. Conversely to this there are the advantageous aspects that the cost is low and that high speed rotation is possible, due to the fact that the rotor includes no permanent magnet. However, with the rotating electrical machine of this embodiment, along with realizing the beneficial effects of a prior art reluctance motor, it is also possible to compensate for its above shortcoming of only having low output torque, so that increase of the performance can be implemented.

In a rotating electrical machine according to the present embodiment, the permanent magnet 300 as a field magnet is further provided on the outer circumference of the stator, and the magnetic flux of this permanent magnet flows the magnetic circuit constituted with stator, flame and rotor. According to the structure of this embodiment, the following beneficial operational effects are obtained.

First, it is possible to set the operating temperature of the magnet 300 lower as compared to a case in which magnets are provided upon the stator poles, because it is possible to cool the magnet 300 easily by taking advantage of the heat dissipation capacity of the frame 100. Due to this, it is possible to employ a low cost magnet whose coercive force decreases easily in higher temperature, so that the overall cost can be reduced. Next, by making the magnet in the form of a single cylinder, it is possible to reduce fluctuations in the performance of the motor due to non-uniform magnetization. Furthermore, because the overall diameter of the magnet is made to be greater than the diameter of the cylinder where the first gap 10 is defined, accordingly a magnetic concentration effect is obtained, in which the magnetic flux is concentrated in the first gap 10. Due to this a sufficient magnetic flux density can be obtained in the first gap, even if a magnet is employed whose residual magnetic flux density is low. Furthermore since, as shown in FIG. 5 and FIG. 7, the magnetic path of the magnet 300 and the magnetic path of the winding 152 constitute different circuits, accordingly the design of the magnetic circuits becomes simple and easy. In addition, it is also possible to mitigate elevation of the temperature of the magnet 300, because the influence of eddy current losses due to slot ripple engendered at the first gap 10 is suppressed. This is due to the fact that the permanent magnets are not exposed to the first gap 10, and therefore the variation of magnetic flux from this permanent magnet due to slot ripple is small, leading to a less eddy current loss caused by this magnetic flux variation.

### Embodiment 2

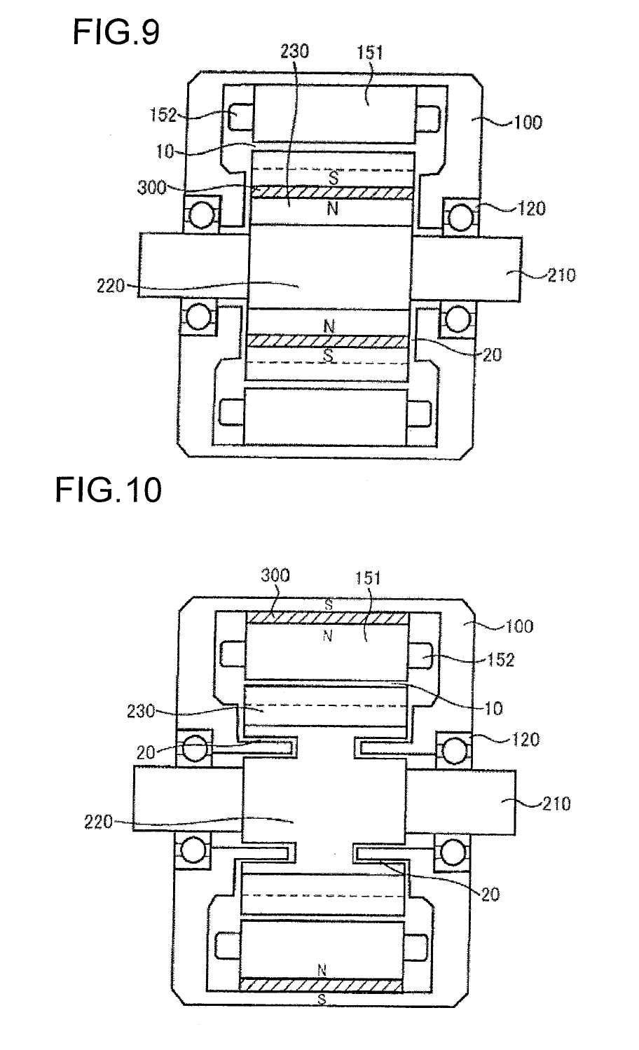

FIG. 9 is a sectional view showing an example of another way of arranging the magnet 300 in the rotor 200. The difference from FIG. 1 is in the position of the magnet 300: in this embodiment, the magnet 300 is provided between the rotor pole 230 and the yoke 220. Since the temperature of the rotor 200 is hard to rise than that of the stator 150, it is possible to enhance the output power while ensuring good cooling performance for the magnet in this embodiment as well, as compared to the case of providing the magnet upon the stator pole.

### Embodiment 3

FIG. 10 is a sectional view of a rotating electrical machine in which the second gaps 20 are extended some way into the central portion of the rotor from both its axial ends. The main structure is close to that shown in FIG. 1, except for the fact that, by reducing the magnetic resistance of the second gaps 20 by providing these second gaps 20 to extend into the yoke 220, it is possible to increase the output torque.

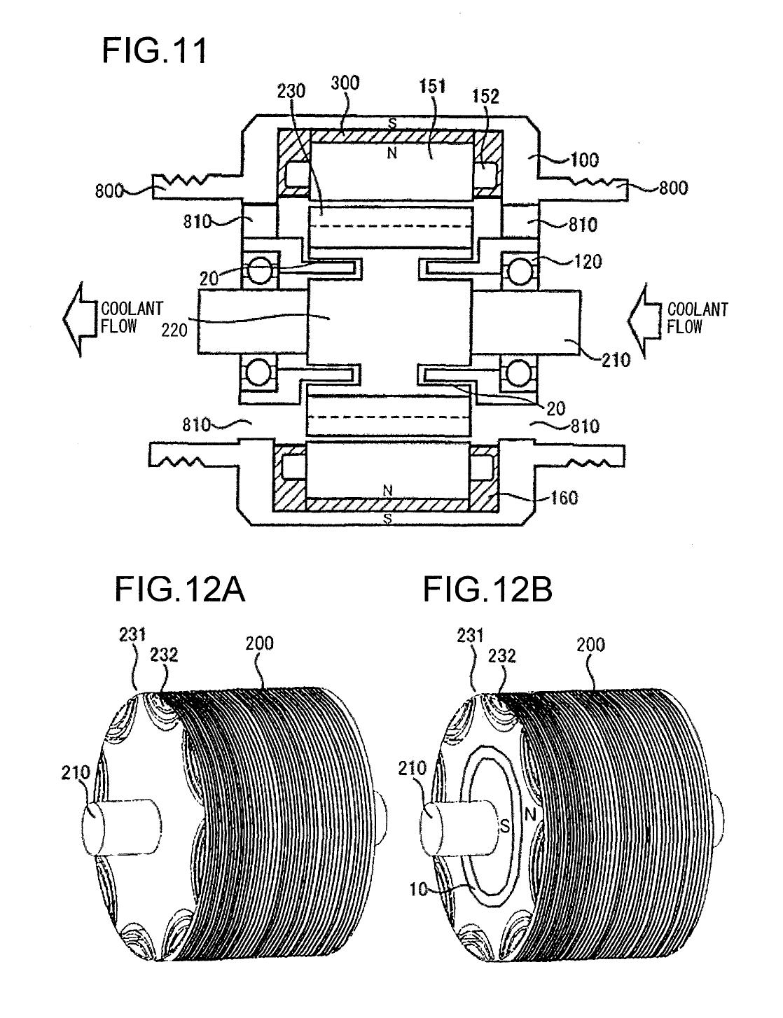

FIG. 11 shows an example in which the structure of FIG. 10 is applied to an axial flow pump. A rotor that is provided with a skew as shown in FIG. 2B corresponds to the impeller of the pump. In the case in which this pump is to be used as a coolant pump for an automobile, the coolant flowing therethrough is for example a mixture of water and ethylene glycol. Accordingly there is little fear of any iron portion rusting, and it is possible to employ the pole of the rotor as such an impeller, just as it is without modification. However for the winding portion of the stator, in consideration of the possibility of electrical leakage and so on, it is ensured that no coolant can penetrate thereinto by embedding them in resin 160.

With this pump, two hose attachment portions 800 are provided at opposite ends thereof along the axial direction of the frame 100, and also a number of apertures 810 for allowing passage of coolant are provided to the frame 100 at the bottom of each of these hose attachment portions 800. It is arranged for the coolant to pass through the concave portions 232 that are the poles of the rotor, and to flow in the direction shown by the arrow signs in the figures.

### Embodiment 4

FIG. 12A is a figure showing an embodiment in which the mechanical reluctance construction of the rotor that has been described with reference to the above embodiments is changed to a magnetic reluctance construction. The rotor of this embodiment is made by laminating together sheets of magnetic steel that have approximately U-shaped cavity portions spaced periodically along their outer edges. Magnetically, these roughly U-shaped cavity portions correspond to the concave portions 232 described above, while the portions between each adjacent pair of cavity portions correspond to the convex portions 231. While the shape of this rotor is different from that of the rotor of FIG. 2, magnetically, it functions in almost the same way. It should be noted that the above approximately U-shaped cavity is filled with a nonmagnetic material or a magnetic material of which permeability is smaller than that of the magnetic steel plates constituting the rotor. As a nonmagnetic material, air may be used.

FIG. 12B shows a variant structure in which a cylindrical magnet is additionally provided at the central portion of the rotor; this structure provides similar advantageous effects to those provided by the structure shown in FIG. 9.

### Embodiment 5

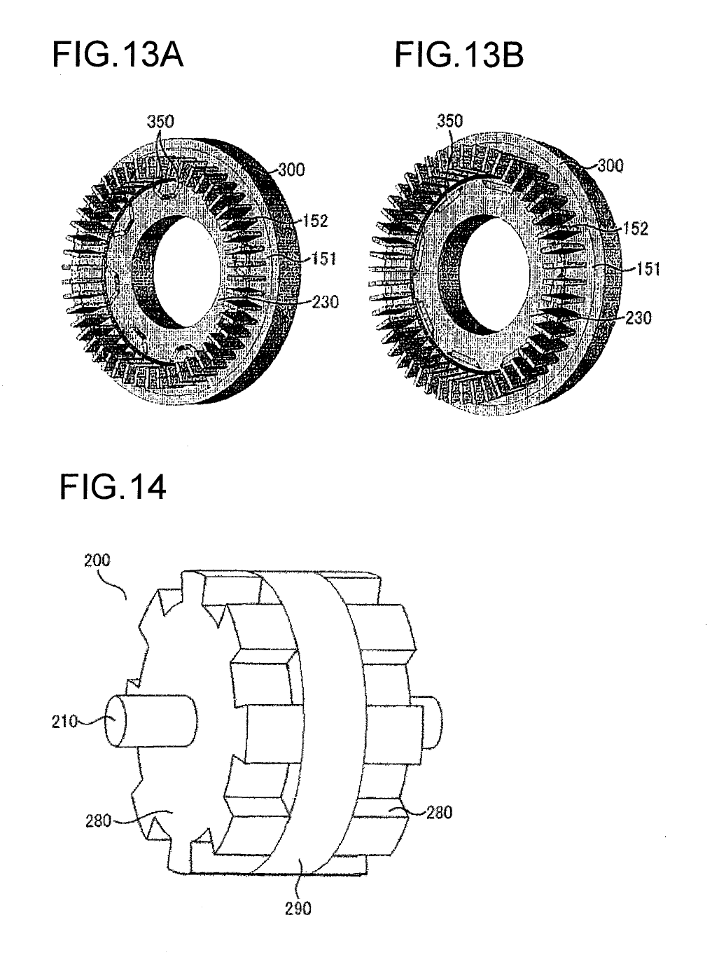

FIGS. 13A and 13B show respectively two exemplary embodiments in a fifth embodiment, where magnets are embedded in its rotor. It should be understood that the coil end of the stator is omitted.

In the structure of FIG. 13A, roughly V-shaped cavity portions are formed periodically around the outer edge portions of the magnetic steel sheets of the rotor by punching out or the like, and permanent magnets 350 are inserted into these cavity portions. And in the structure of FIG. 13B, roughly I-shaped cavity portions are formed periodically around the outer edge portions of the magnetic steel sheets of the rotor, and permanent magnets 350 are inserted into these cavity portions. Magnetically, these cavity portions correspond to the concave portions 232 of the FIG. 2 structure, while the portions between each adjacent pair of cavity portions correspond to the convex portions 231. By arranging the magnet 300 around the external circumferential surface of either of these stators, it is possible to increase the magnetic flux density in the first gap 10, and it may be anticipated that the output torque will be increased.

### Embodiment 6

For the rotor of FIG. 1, it would also be possible to employ a combination of an iron core rotor of a reluctance motor and a surface magnet rotor of a magnet motor. FIG. 14 shows an example of this combination: this rotor structure includes an iron core rotor 280 at each of the two end surfaces in the axial direction, and a surface magnet rotor 290 at the central portion in the axial direction. With a rotor having this type of structure, it is possible to enhance the output power in a similar manner to that described above.

While motors of an inner-rotor type have been explained in the various embodiments described above, the present invention can also be applied to a generator or to an outer-rotor type motor. In the case of an outer-rotor type motor as well, the positional relationship between the magnet and the frame made from a magnetic material is the same as the inner-rotor type motor. Moreover, while a magnet 300 is used in the above embodiments, it would also be acceptable to employ a member that can generate magnetism, for example an electromagnet or the like. Furthermore, this type of magnet is not limited to being perfectly cylindrical in shape; it would also be acceptable to provide a plurality of magnets separated along the circumferential direction. In any of these cases, it is possible to enhance the output power while ensuring good cooling performance for the magnet.

It should be noted that the above mentioned reluctance structure of the rotor, referring FIG. 12A, may include both the mechanical reluctance structure and the magnetic structure.

The above described embodiments are examples; various modifications can be made without departing from the scope of the invention.

What is claimed is:

1. A rotating electrical machine comprising a stator, a rotor, a magnet, and a frame, wherein:
the rotor has a mechanical and/or a magnetic reluctance structure;
the magnet is provided between an outer circumferential surface of the stator in circumferential direction and an inner circumferential surface of the frame in circumferential direction; and
the frame is made of magnetic material.

2. A rotating electrical machine according to claim 1, wherein:
the rotor has, on its surface that opposes the stator, a plurality of convex portions along its direction of rotation; and
the stator has a same number of poles as a number of convex portions of the rotor.

3. A rotating electrical machine according to claim 1, wherein:
the rotor has a substantially U-shaped cavity portion on its outer edge portion; and
the stator has a same number of poles as a number of convex magnetic poles of the rotor.

4. A rotating electrical machine according to claim 2, wherein the rotor is made from a plurality of plates of magnetic material, superimposed along axial direction and skewed along axial direction.

5. A rotating electrical machine according to claim 1, wherein the magnet is a cylindrical permanent magnet, and is single-pole magnetized in its radial direction

6. A rotating electrical machine according to claim 1, wherein the magnet is an electromagnet.

7. A rotating electrical machine according to claim 1, wherein the magnet is constituted with a plurality of permanent magnet portions made by dividing a cylindrical permanent magnet in its axial direction, and is provided between an outer circumferential surface of the stator in circumferential direction and an inner circumferential surface of the frame in circumferential direction; wherein the cylindrical permanent magnet is single-pole magnetized in its radial direction.

8. A rotating electrical machine comprising a stator, a rotor, a frame, and a plurality of magnets, wherein:
the rotor has a mechanical and/or a magnetic reluctance structure, and has a substantially U-shaped cavity portion on its outer edge portion; and
the stator has a same number of poles as a number of convex magnetic poles of the rotor;
the magnets are embedded in the rotor, corresponding in number to the number of the convex magnetic poles of the rotor; and
the frame is made of magnetic material.

9. A rotating electrical machine comprising a stator, a rotor supported by a shaft, a permanent magnet, and a frame, wherein:
the rotor has a mechanical or magnetic reluctance structure; and
the permanent magnet is disposed between an outer circumferential surface of the rotor and the shaft.

10. A rotating electrical machine according to claim 1, wherein a magnetic circuit is set up in the frame so that a magnetic flux of the magnet flows from both central portions of both axial ends of the rotor towards both central portions of both axial ends the frame, where both of axial ends of the frame face respectively to both central portions of the rotor.

11. An axial flow pump that uses a rotor according to claim 2 as an impeller.
